(19) United States
(12) Patent Application Publication
(10) Pub. No.: US 2015/0338714 A1
(43) Pub. Date: Nov. 26, 2015

(54) DISPLAY PANEL AND DISPLAY DEVICE

(71) Applicant: BOE TECHNOLOG GROUP CO., LTD., Beijing (CN)

(72) Inventor: Mingchao LI, Beijing (CN)

(73) Assignee: BOE TECHNOLOGY GROUP CO., LTD., Beijing (CN)

(21) Appl. No.: 14/389,121

(22) PCT Filed: Dec. 18, 2013
(86) PCT No.: PCT/CN2013/089798

§ 371 Date: Sep. 29, 2014

(30) Foreign Application Priority Data
Aug. 23, 2013 (CN) 201310372886.8

(51) Int. Cl. G02F 1/163; G02F 1/157; G02F 1/1333; G02F 1/1368; G02F 1/1335

(52) U.S. Cl. CPC G02F 1/163; G02F 1/1368; G02F 1/133512; G02F 1/133345; G02F 1/133514; G02F 1/157; G02F 2001/1635

(57) ABSTRACT

The invention provides a display panel and a display device including the same, which belong to the field of display technology and can achieve a selective switch between a transparent color display and a transparent black-and-white display. The display panel of the invention includes: a display panel for performing display which includes a plurality of pixel units; a plurality of color changing units located at positions corresponding to the respective positions of the plurality of pixel units of the display unit and made of electrochromic material; and color controlling units for controlling color changes of the respective color changing units. The display panel and the display device including the same according to the invention utilize new color changing units and thus can achieve a selective switch between a transparent color display and a transparent black-and-white display.

### FIELD OF THE INVENTION

The invention relates to the field of display technology, and particularly relates to a display panel and a display device including the display panel.

### BACKGROUND OF THE INVENTION

With the increasing demand for an information display, the liquid crystal display among the flat panel displays, which utilizes optical anisotropy of the liquid crystal molecules to display images, has been widely used due to its excellent resolution, color display, image quality, etc.

A display panel not only can realize the display of images, but also can make objects behind it visible. So, transparent display technology becomes a focus of researches. The display panel of this type can be applied to vehicle windshield and residential glass to provide information required by a user.

The image display necessarily involves the display of color images, and the conventional display panel uses a color film substrate to achieve the color image display, which cannot selectively switch between the color display and the black-and-white display. Thus, a new color changing unit is required to allow the display panel to selectively switch between the transparent color display and the transparent black-and-white display.

The electrochromic phenomenon refers to a phenomenon in which optical properties of a material are caused to change stably and reversibly under the action of an electric field, and it corresponds to the photochromic phenomenon and the thermochromic phenomenon. Generally, such a reversible change occurs between a colorless transparent state and a colored state, or between two different colors. The principle of electrochromic behaviors mainly depends on the structure of energy bands and the redox properties of the chemical composition of the material. The absorption characteristics of the material in the visible light region may be modulated by means of injection/suction of ions or electrons, and the infrared reflection characteristics of the material may be modulated by changing carrier concentration or plasma oscillation frequency. The electrochromic materials are divided into three categories: transition metal oxides, organic low molecular weight compounds, and polymers, among which studies on tungsten trioxide and viologen are reported most.

### SUMMARY OF THE INVENTION

An object of the invention is to provide a display panel which can achieve a selective switch between a transparent color display and a transparent black-and-white display, so as to solve the problem that the conventional display panel cannot selectively switch between these two states.

A technical solution to solve the above technical problem is a display panel according to the invention, which includes:

a display unit for performing display, wherein the display unit includes a plurality of pixel units;

a plurality of color changing units located at positions corresponding to the respective positions of the plurality of pixel units of the display unit and made of electrochromic material; and

color controlling units for controlling color changes of the respective color changing units.

Preferably, the color controlling units are located at light outgoing side or light incident side of the color changing units.

Further preferably, the respective color controlling unit includes a first array substrate, wherein the first array substrate sequentially includes, from one side thereof, a thin film transistor, a first electrode, an insulation layer and a second electrode; wherein a drain electrode of the thin film transistor is connected to the first electrode, and an electric field is generated between the first electrode and the second electrode when a voltage is applied therebetween; and wherein the respective color changing unit is provided on a side of the second electrode which is away from the first electrode.

Further preferably, the respective color controlling unit includes a first array substrate, wherein the first array substrate includes a thin film transistor, an insulation layer, a first electrode and a second electrode; wherein the first electrode and the second electrode are interlaced and distributed in the same layer with the insulation layer provided therebetween; wherein a drain electrode of the thin film transistor is connected to the first electrode, and an electric field is generated between the first electrode and the second electrode when a voltage is applied therebetween; and wherein the respective color changing unit is provided on the first and the second electrodes and is controlled by the electric field generated between these two electrodes.

Further preferably, the respective color controlling unit includes a first array substrate, wherein the first array substrate includes a thin film transistor, an insulation layer, a first electrode and a second electrode; wherein a drain electrode of the thin film transistor is connected to the first electrode, and an electric field is generated between the first electrode and the second electrode when a voltage is applied therebetween; and wherein the respective color changing unit is provided between the first electrode and the second electrode of the first array substrate.

Preferably, a black matrix is provided among the plurality of color changing units.

Further preferably, the display unit is any one of a liquid crystal display unit, an organic light emitting diode display unit, and a plasma display unit.

When the display unit is a liquid crystal display unit, the respective pixel unit of the liquid crystal display unit preferably includes a second array substrate which sequentially includes, from one side thereof, a common electrode, an insulation layer, a pixel electrode and a liquid crystal layer.

Preferably, the electrochromic material is a metal-organic chelate.

Preferably, the metal-organic chelate is a rare-earth phthalocyanine represented by the structure below:

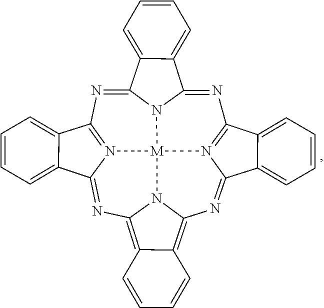

wherein M is a metal of lanthanide series (also referred to as “lanthanide metal”).

Preferably, the lanthanide metal is Lu.

Another object of the invention is to provide a display device capable of selectively switching between a transparent color display and a transparent black-and-white display, so as to achieve the selective switch between these two states.

A technical solution to solve the above technical problem is a display device including the display panel according to the invention.

The display panel and the display device according to the invention can achieve a selective switch between the transparent color display and the transparent black-and-white display, due to the novel color changing units provided therein. The display panel and the display device of the invention are useful for high quality transparent display products.

### BRIEF DESCRIPTION OF THE DRAWINGS

FIG. 1 illustrates a structural schematic view of a part of a display panel with color controlling units provided at light outgoing side of color changing units according to a preferred embodiment of the invention.

FIG. 2 illustrates a structural schematic view of a part of a display panel with color controlling units provided at light incident side of color changing units according to a preferred embodiment of the invention.

FIG. 3 illustrates a structural schematic view of a part of a display panel with first electrodes and second electrodes both being strip electrodes according to a preferred embodiment of the invention.

FIG. 4 illustrates a structural schematic view of a part of a display panel with color changing units provided between electrodes of color controlling units according to a preferred embodiment of the invention.

FIG. 5 illustrates the molecular structure of rare-earth phthalocyanine as an organic metal chelate used in Embodiment 1 of the invention.

Reference numbers: 1. glass substrate; 2. first electrode; 3. insulation layer; 4. second electrode; 5. color changing unit; 6. black matrix; 7. alignment layer; 8. liquid crystal layer; 9. pixel electrode; 10. common electrode; 11. first array substrate; 12. second array substrate; 13. pixel unit; 14. polarizer; 15. color controlling unit.

### DETAILED DESCRIPTION OF CERTAIN EMBODIMENTS

In order to make persons skilled in the art better understand technical solutions of the invention, the invention will be detailed described below in conjunction with the drawings and the embodiments.

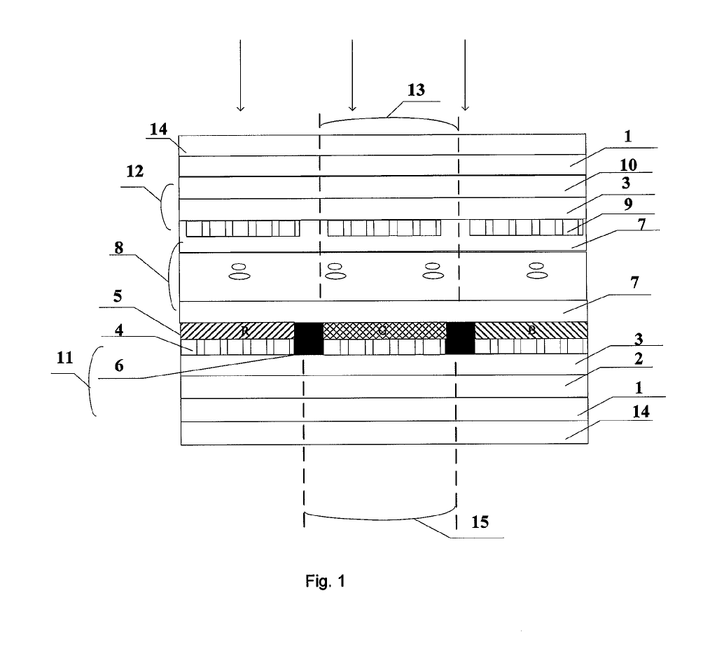

An embodiment of the invention provides a display panel, as shown in FIG. 1, which includes a display unit for performing display, color changing units 5 arranged at light outgoing side of the display unit (as shown in FIG. 1, the three arrows direct the light incident direction), and color controlling units 15 arranged at light outgoing side of the color changing units 5. The embodiment is described by taking a liquid crystal display unit as an example (in the invention, the liquid crystal display unit mainly functions to control the amount of light transmission of the respective pixel unit). As shown in FIG. 1, the liquid crystal display unit includes a plurality of pixel units 13. The respective pixel unit 13 includes a glass substrate 1, as well as a common electrode 10, an insulation layer 3, a pixel electrode 9 and a liquid crystal layer 8 sequentially provided at light outgoing side of the glass substrate 1, wherein the liquid crystal layer 8 includes, at both sides thereof, alignment layers 7. The glass substrate 1, the common electrode 10, the insulation layer 3 and the pixel electrodes 9 constitute a second array substrate.

The color changing units 5 are made of electrochromic material (in the invention, the color changing units 5 can achieve color display), and located at positions corresponding to the respective positions of the pixel units 13. A black matrix 6 is provided among the color changing units 5 to prevent color blending, enhance color purity and increase the aperture ratio.

The color controlling units 15 are used to control the color change of the color changing units 5. As shown in FIG. 1, the respective color controlling unit 15 includes a first array substrate 11 which includes a glass substrate 1, a thin film transistor, a first electrode 2, an insulation layer 3, and a second electrode 4. The first electrode 2 in the respective color controlling unit 15 is connected to a drain electrode of the thin film transistor, and an electric field can be generated between the second electrode 4 and the first electrode 2 with a voltage applied therebetween. In the embodiment as shown in FIG. 1, the color controlling units 15 are located at the light outgoing side of the color changing units 5, and voltages of the respective color changing units 5 at various times are controlled by the first array substrate 11 so as to effect control of the colors of the respective color changing units 5.

It should be noted that the first electrode 2 in each of the color controlling units 15 in FIG. 1 is individually controlled by a thin film transistor, which is not shown in FIG. 1.

The color changing units of the invention are made of electrochromic material which will exhibit different colors under the control of particular voltages, and thus the display can be performed by applying particular voltages to the color changing units according to display requirements. As known by persons skilled in the art, generally, an array substrate drives the deflection of liquid crystal molecules by controlling the voltage between electrodes, thereby achieving the display function of a display panel. In the invention, the array substrate is used not only for driving the deflection of liquid crystal molecules, but also for driving the color change of the color changing units.

The color changing units in the display panel of the invention are formed by directly depositing electrochromic material after formation of the last layer of electrodes of the first array substrate 11. The voltage of the respective color changing unit is controlled by a corresponding thin film transistor, so that the voltage applied to the color changing unit can be adjusted as desired to control the color of the color changing unit.

As described above, the display panel in the prior art generally includes an array substrate which is mainly used for driving the deflection of liquid crystal molecules, such that deflection angles of the liquid crystal molecules can be controlled by controlling the amplitudes of the applied voltages. However, the display panel according to the invention includes two array substrates, one being a conventional array substrate for driving the deflection of liquid crystal molecules, and the other serving as the color controlling units to control the color change of the color changing units coated on its electrodes such that the colors to be exhibited by the color changing units are controlled by controlling the amplitudes of applied voltages.

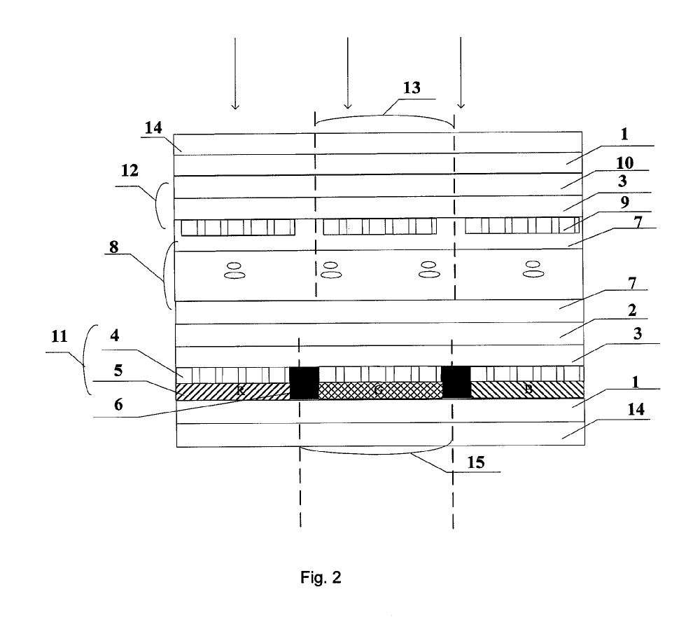

In another embodiment of the invention, as shown in FIG. 2, the color controlling units 15 may also be provided at the light incident side of the color changing units 5 (in FIG. 2, the three arrows direct the light incident direction). The respective color controlling unit 15 includes a first array substrate 11 which includes a glass substrate 1, a thin film transistor, a first electrode 2 and a second electrode 4. The first electrode 2 in the respective color controlling unit 15 is connected to a drain electrode of the thin film transistor, and an electric field can be generated between the second electrode 4 and the first electrode 2 with a voltage applied therebetween. The color controlling units 15 are located on the color changing units 5, and voltages of the respective color changing units 5 at various times are controlled by the first electrodes 2 and the second electrodes 4 of the first array substrate 11 so as to effect control of the colors of the respective color changing units 5. Similarly to the display panel in the embodiment as shown in FIG. 1, the color changing units 5 in the display panel of the present embodiment are also coated on the second electrodes 4 of the first array substrate 11, such that the voltages of the respective color changing units are controlled by the first array substrate 11 so as to effect control of the colors of the respective color changing units.

It should be noted that the first electrode 2 in each of the color controlling units 15 in FIG. 2 is individually controlled by a thin film transistor, which is not shown in FIG. 2.

As shown in FIGS. 1 and 2, for the arrangement of the first electrodes 2 and the second electrodes 4 in the color controlling units 15, the first electrodes 2 are plate-shaped and the strip-shaped second electrodes 4 are provided on the plate-shaped first electrodes 2 with the insulation layer 3 sandwiched therebetween, such that a driving electric field may be generated. Of course, it is also feasible that the second electrodes 4 are plate-shaped and the first electrodes 2 are strip-shaped, as long as the electrodes which are closer to the color changing units 5 are strip-shaped electrodes.

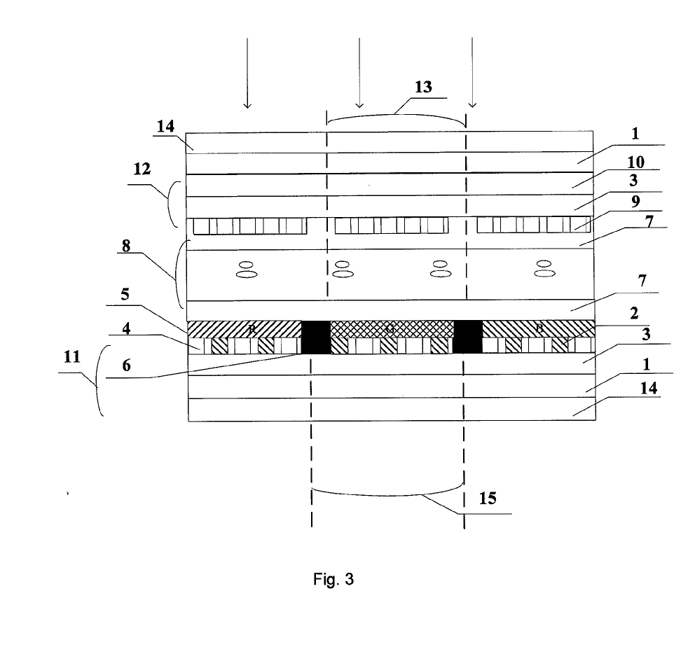

Alternatively, the first electrodes 2 and the second electrodes 4 in the color controlling units 15 may be arranged as shown in FIG. 3. In this embodiment, both the first electrodes 2 and the second electrodes 4 are strip-shaped, which are located between the insulation layer 3 and the color changing units 5, and which are interlaced and distributed in the same layer so as to generate driving electric field.

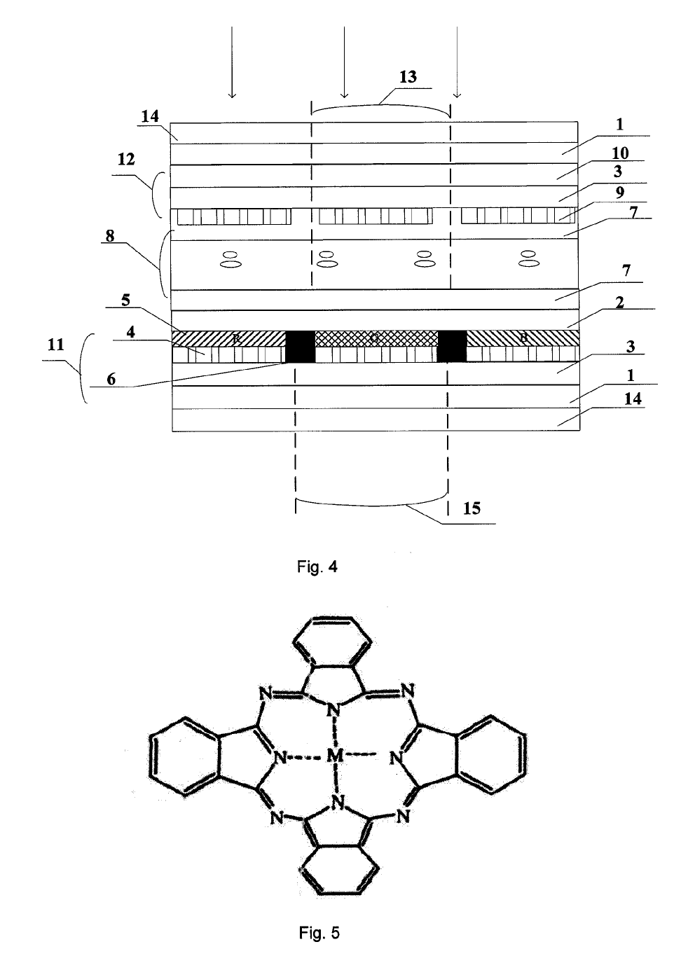

In yet another embodiment of the invention, as shown in FIG. 4, the respective color controlling unit 15 includes a glass substrate 1, a thin film transistor, a first electrode 2 and a second electrode 4. The first electrode 2 in the color controlling unit 15 is connected to a drain electrode of the thin film transistor, and an electric field can be generated between the second electrode 4 and the first electrode 2 with a voltage applied therebetween. The glass substrate, the thin film transistors, the first electrodes 2 and the second electrodes 4 constitute the first array substrate 11. The color changing units 5 are provided between the first electrodes 2 and the second electrodes 4 of the color controlling units 15. Voltages of the respective color changing units 5 at various times are controlled by the first array substrate 11 so as to effect control of the colors of the respective color changing units 5.

The said first array substrate 11 may be configured to have a suitable structure according to a particular application situation of the display panel so as to achieve an optimum display effect. Also, the first array substrate 11 may be selected from other kinds of array substrates in the prior art, but the driving electric field generated by the first array substrate 11 is not used to drive the liquid crystal molecules, but to change the color of the electrochromic material in the color changing units 5.

Of course, it should be understood that the first array substrate 11 including the color controlling units 15 is preferably configured as above since the manufacturing processes for the various array substrates are already mature, and the production of workpieces is simple and cost effective. However, the color controlling units 15 may be configured otherwise, as long as they can control the voltages applied to the respective color changing units 5.

The second array substrate 12 is used to control the transparent black-and-white display of the display unit. Preferably, the second array substrate 12 has the same structure as the first array substrate 11, such that the said first array substrate 11 and the second array substrate 12 may be fabricated using the same manufacturing process. Of course, the second array substrate 12 may also be fabricated using other technologies in the art.

The voltages applied to the color changing units 5 can be controlled by the color controlling units 15, so as to effect the switch between the color (R, G, or B) display and the transparent display. As shown in FIG. 1, the color changing units 5 form R, G and B color regions under different voltages at a certain time.

With the display panel, a selective switch between the transparent black-and-white display and the transparent color display can be achieved by controlling the liquid crystal display units and the color changing units 5. Particularly, when both the liquid crystal display units and the color changing units 5 are turned on, the display panel is performing the transparent color display; when the liquid crystal display units are turned on and the color changing units 5 are turned off, the display panel is performing the transparent black-and-white display.

Preferably, the electrochromic material has a molecular structure as shown in FIG. 5, wherein M is a lanthanide metal such as Lu.

When Lu is in a trivalent state, active hydrogen remains in the complex, and the molecular formula thereof may be abbreviated as MH(Pc)₂, wherein Pc represents (C₃₂H₁₆N₈)²⁻. LuH(Pc)₂ film exhibits different colors under different voltages. When the voltage is in the range of 0.1±0.01V, the LuH(Pc)₂ film exhibits red; when the voltage is in the range of 0±0.01V, the LuH(Pc)₂ film exhibits green; when the voltage is in the range of −0.8±0.01V, the LuH(Pc)₂ film exhibits blue; and when the voltage is in the range of −1.2±0.01V, the LuH(Pc)₂ film exhibits purple.

The exhibition of different colors under different voltages is achieved by the electronic energy level transition of the electrochromic material itself. Particularly, when the transition metal ion and the multi-ligand form the chelate, d orbit of the metal ion splits, under the effect of the ligand, into a T2g orbit at a lower energy level and a Eg orbit at a higher energy level. The energy level difference $ between these two orbits often falls within the visible light range, so that the metal chelate exhibits a complementary color to $.

As described above, the electrochromic material exhibits different colors under different voltages. Thus, it is possible to apply different voltages to the electrochromic material to make it exhibit different colors according to the display requirements of the display panel.

Of course, as a complete display panel, it may be necessary to include other essential component(s), for example, two polarizers arranged at the external layers of the display panel, etc., which will not be particularly limited herein.

The display panel operates as follows: when the first array substrate 11 and the second array substrate 12 are turned on at the same time, the display panel performs the transparent color display; when the first array substrate 11 is not turned on and the second array substrate 12 is turned on, the display panel performs the transparent black-and-white display. The display panel can selectively switch between the transparent color display and the transparent black-and-white display by the control of the first array substrate 11 and the second array substrate 12.

### EXAMPLES

In the following, a method for fabricating a display panel will be described in detail by taking the array substrate shown in FIG. 1 as an example. Of course, the array substrate may be an array substrate with other structure known in the prior art, which will not be particularly limited herein.

### Embodiment 1

The method for fabricating the display panel as shown in FIG. 1 includes the following steps:

1. Fabricating a First Array Substrate

This step is performed by fabricating the first array substrate 11 on a glass substrate 1 through a patterning process, wherein the first array substrate 11 includes thin film transistors (not shown in FIG. 1), first electrodes 2, an insulation layer 3 and second electrodes 4. Since the manufacturing process of the thin film transistors is known in the art, it is unnecessary to describe in detail herein.

Specifically, in this example, color changing units 5 are formed by depositing a layer of electrochromic material LuH(Pc)₂ on the second electrodes 4 of the first array substrate 11, through a depositing-photoetching process. Of course, the color changing units 5 may also be formed by coating the electrochromic material LuH(Pc)₂ through an inkjetting process. Then, a black matrix 6 is prepared among the color changing units 5 so as to prevent light leaking and increase color contrast. The first array substrate 11 controls voltages of the various color changing units 5, thereby achieving the switch between the color (R, G and B) display and the black-and-white display.

The particular configuration of the color controlling units is not limited in the invention, as long as the color controlling units can apply different voltages to the color changing units according to the display requirements. In the invention, the color controlling unit is described by taking the array substrate commonly used in the art to perform display as an example, since its manufacturing process is similar to that of the array substrate used to perform display and thus the manufacturing cost will be saved. In the invention, the particular configuration of the array substrate functioning as the color controlling unit is not limited, as long as the color controlling unit can generate electric fields between two electrodes at various times for controlling the corresponding color changing unit according to the display requirements.

2. Fabricating an Alignment Layer

This step is performed by depositing a layer of dielectric resin on the first array substrate 11 obtained in Step 1, and then performing a process for preparing the alignment layer 7 followed by curing the same. A polyimide (PI) coating serves as a parallel alignment layer 7. The PI may be printed repeatedly so as to increase the PI thickness, as the level difference between the black matrix 6 and the electrochromic material will be eliminated with increased PI thickness. Then, a rubbing process is performed to form the alignment layer on the first array substrate 11.

3. Fabricating a Second Array Substrate and Another Alignment Layer

Preferably, the manufacturing process of the second array substrate 12 may be selected to be the same as that of the first array substrate 11 in Step 1 (the first array substrate and the second array substrate have identical structure but different functions). For example, the second array substrate 12 includes pixel electrodes 9, an insulation layer 3, and a common electrode 10. When the first array substrate 11 and the second array substrate 12 are formed by the same manufacturing process, the display panel can be fabricated on the same production line, which is relatively simple and cost effective.

With the same process as described in Step 2, a PI liquid is directly printed on the second array substrate 12 followed by a rubbing process to form the alignment layer on the second array substrate 12.

4. Injecting Liquid Crystal and Assembling

This step is performed by injecting liquid crystal to form a liquid crystal layer 8, after the alignment layers are formed respectively on the first array substrate 11 and the second array substrate 12 in Step 2 and Step 3. Then, the first array substrate 11 and the second array substrate 12 are assembled to form an ADS mode transparent display liquid crystal cell.

5. Fabricating a Display Panel

This step is performed by providing polarizers 14 on both sides of the transparent display liquid crystal cell to obtain a display panel. Light transmittance is regulated by adjusting the angles of the said polarizers 14.

Optionally, the display panel may be used to fabricate various kinds of transparent display devices.

### Embodiment 2

This example provides a display device including the above display panel. The manufacturing process of the display device is commonly known in the art and it is unnecessary to describe in detail herein.

Unlike Embodiment 1, the angle between the two polarizers 14 in Embodiment 2 is always 90°.

It should be understood that the above embodiments are merely exemplary embodiments used to describe the principle of the invention, and the invention is not limited thereto. For persons skilled in the art, various modifications and improvements may be made without departing from the spirit and substance of the invention and these modifications and improvements should be considered to be within the protection scope of the invention.

1. A display panel, characterized in that the display panel includes:
a display unit for performing display, wherein the display unit includes a plurality of pixel units;
a plurality of color changing units located at positions corresponding to the respective positions of the plurality of pixel units of the display unit and made of electrochromic material; and
color controlling units for controlling color changes of the respective color changing units.

2. The display panel of claim 1, wherein the color controlling units are located at light outgoing side or light incident side of the color changing units.

3. The display panel of claim 2, wherein the respective color controlling unit includes a first array substrate, wherein the first array substrate sequentially includes, from one side thereof, a thin film transistor, a first electrode, an insulation layer and a second electrode, wherein a drain electrode of the thin film transistor is connected to the first electrode, and an electric field is generated between the first electrode and the second electrode when a voltage is applied therebetween; and
wherein the respective color changing unit is provided on a side of the second electrode which is away from the first electrode.

4. The display panel of claim 1, wherein the respective color controlling unit includes a first array substrate, wherein the first array substrate includes a thin film transistor, an insulation layer, a first electrode and a second electrode, wherein the first electrode and the second electrode are interlaced and distributed in the same layer with the insulation layer provided therebetween, a drain electrode of the thin film transistor is connected to the first electrode, and an electric field is generated between the first electrode and the second electrode when a voltage is applied therebetween; and
wherein the respective color changing unit is provided on the first electrode and the second electrode and is controlled by the electric field generated between these two electrodes.

5. The display panel of claim 1, wherein the respective color controlling unit includes a first array substrate, wherein the first array substrate includes a thin film transistor, an insulation layer, a first electrode and a second electrode, wherein a drain electrode of the thin film transistor is connected to the first electrode, and an electric field is generated between the first electrode and the second electrode when a voltage is applied therebetween; and
wherein the respective color changing unit is provided between the first electrode and the second electrode of the first array substrate.

6. The display panel of claim 1, wherein a black matrix is provided among the plurality of color changing units.

7. The display panel of claim 1, wherein the display unit is a liquid crystal display unit.

8. The display panel of claim 7, wherein the pixel units of the liquid crystal display unit include a second array substrate, and wherein the second array substrate sequentially includes, from one side thereof, a common electrode, an insulation layer, pixel electrodes and a liquid crystal layer.

9. The display panel of claim 1, wherein the display unit is any one of an organic light emitting diode display unit and a plasma display unit.

10. The display panel of claim 1, wherein the electrochromic material is a metal-organic chelate.

11. The display panel of claim 10, wherein the metal-organic chelate is a rare-earth phthalocyanine represented by the structure below: 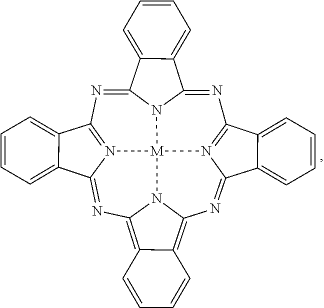
wherein M is a lanthanide metal.

12. The display panel of claim 11, wherein the lanthanide metal is Lu.

13. A display device, characterized in that the display device includes a display panel of including:
a display unit for performing display, wherein the display unit includes a plurality of pixel units;
a plurality of color changing units located at positions corresponding to the respective positions of the plurality of pixel units of the display unit and made of electrochromic material; and
color controlling units for controlling color changes of the respective color changing units.
